(19) United States
(12) Patent Application Publication
(10) Pub. No.: US 2024/0059171 A1
(43) Pub. Date: Feb. 22, 2024

(54) ELECTRIC VEHICLE AND POWER CONTROL METHOD OF SAME

(71) Applicants: Hyundai Motor Company, Seoul (KR); Kia Corporation, Seoul (KR)

(72) Inventors: Won Jae Lee, Suwon-Si (KR); Gi Young Kwon, Seoul (KR)

(73) Assignees: Hyundai Motor Company, Seoul (KR); Kia Corporation, Seoul (KR)

(21) Appl. No.: 18/117,895

(22) Filed: Mar. 6, 2023

(30) Foreign Application Priority Data
Aug. 22, 2022 (KR) 10-2022-0105007

(51) Int. Cl. B60L 53/62; B60L 50/60; B60L 53/80; B60L 58/18; B60L 15/20; H02J 7/00; H01M 10/44; H01M 10/48

(52) U.S. Cl. CPC B60L 53/62; B60L 50/60; B60L 53/80; B60L 58/18; B60L 15/20; H02J 7/0013; H02J 7/00712; H02J 7/0048; H01M 10/441; H01M 10/48; H02J 2310/48; H01M 2220/20

(57) ABSTRACT

A power control method of an electric vehicle, includes determining whether the vehicle is started, and controlling discharging of a main battery to be performed after discharging a swap battery, or controlling charging of the swap battery to be performed after charging the main battery according to whether the vehicle is started, based on maximum charge and discharge powers of each of the main battery and the swap battery.

### CROSS REFERENCE TO RELATED APPLICATION

The present application claims priority to Korean Patent Application No. 10-2022-0105007, filed on Aug. 22, 2022, the entire contents of which is incorporated herein for all purposes by this reference.

### BACKGROUND OF THE PRESENT DISCLOSURE

### Field of the Present Disclosure

The present disclosure relates to an electric vehicle having a main battery and a swap battery and a power control method of the same, in which when battery discharge is required, the discharging of the swap battery is preferentially performed, and when battery charge is required, the charging of the main battery is preferentially performed.

### Description of Related Art

Recently, with increasing interest in the environment, electric vehicles provided with an electric motor as a power source are increasing.

Even though a significant number of users of an electric vehicle have a driving pattern centered on short-distance downtown, the electric vehicle has a relatively long battery charging time compared to the refueling time of an internal combustion engine vehicle, so that the maximum driving distance of the electric vehicle through one full charge is important.

However, when increasing battery capacity to increase the driving distance of the electric vehicle, the weight of the electric vehicle increases, and the price of the electric vehicle increases significantly because the price of a battery takes up a large portion of the price of the electric vehicle. Furthermore, due to the increased battery capacity, it takes a long time to fully charge the battery.

To solve the problems of reduced mileage and charging time due to battery deterioration, some manufacturers are considering the method of replacing the battery by making it detachable. In the case of small mobility such as electric scooters, a low-voltage/low-capacity battery may be applied thereto and a user can exchange the battery directly, but it is difficult for a user to directly replace a Large-capacity battery for a vehicle due to weight and safety issues, so a dedicated infrastructure is required. However, to expand the infrastructure for battery replacement, it is necessary to secure a site and replacement equipment at a large cost, and even if the infrastructure is in place, driving itself is difficult when there is physical damage to a fastening part or damage to a contact by a fire as the number of batteries replaced increases.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric vehicle including a main battery and a swap battery and a power control method of the same in which when battery discharge is required, the discharging of the swap battery is preferentially performed and when the battery charge is required, the charging of the main battery is preferentially performed so that the SOC value of the main battery is secured.

Technical objectives to be achieved in an exemplary embodiment of the present disclosure are not limited to the technical objective mentioned above, and other technical objectives not mentioned above will be clearly understood to those skilled in the art to which an exemplary embodiment of the present disclosure belongs from the following description.

In various aspects of the present disclosure, there is provided a power control method of an electric vehicle, the method including: determining whether the vehicle is started; and controlling discharging of a main battery to be performed after discharging a swap battery, or charging of the swap battery to be performed after charging the main battery according to whether the vehicle is started, based on maximum charge and discharge powers of each of the main battery and the swap battery.

For example, the controlling may include determining a driver demand power when the vehicle is started.

For example, the controlling may further include: controlling the discharging of the swap battery to be performed by the maximum discharge power of the swap battery, and controlling the discharging of the main battery to be performed by a difference between the driver demand power and the maximum discharge power of the swap battery when the driver demand power is greater than the maximum discharge power of the swap battery when the vehicle is started and the driver demand power requires battery discharge.

For example, the controlling may further include: controlling the discharging of the swap battery to be performed by the driver demand power when the main battery is not capable of being charged or discharged after checking whether the main battery is capable of being charged or discharged when the driver demand power is the maximum discharge power of the swap battery or less than the maximum discharge power of the swap battery.

For example, the controlling may further include: controlling the discharging of the swap battery to be performed by the maximum discharge power of the swap battery, and controlling the charging of the main battery to be performed by a difference between the maximum discharge power of the swap battery and the driver demand power when the main battery is capable of being charged or discharged.

For example, the controlling may further include controlling the charging of the main battery to be performed by the driver demand power when the driver demand power is the maximum charge power of the main battery or less than the maximum charge power of the main battery when the vehicle is started, and the driver demand power requires battery charge.

For example, the controlling may further include: controlling the charging of the main battery to be performed by the maximum charge power of the main battery, and controlling the charging of the swap battery to be performed by a difference between the driver demand power and the maximum charge power of the main battery when the driver demand power is greater than the maximum charge power of the main battery.

For example, the controlling may further include checking whether charging by an external charger is performed when a state of charge (SOC) value of the swap battery is not equal to a preset first reference value or is less than the preset first reference value when the starting of the vehicle stops.

For example, the controlling may further include controlling the charging of the main battery to be performed by the swap battery when the charging by the external charger is not performed.

For example, the controlling may further include controlling the charging of the swap battery to be performed by a discharge power of the external charger when the main battery is fully charged and the SOC value of the swap battery is a preset second reference value or less than the second reference value when the charging by the external charger is performed.

For example, the controlling may further include comparing the maximum charge power of the main battery with the discharge power of the external charger when the charging by the external charger is performed and the main battery is not fully charged.

For example, the controlling may further include: controlling the charging of the main battery to be performed by the discharge power of the external charger; and controlling the swap battery so that the swap battery charges the main battery by a difference between the maximum charge power of the main battery and the discharge power of the external charger when the maximum charge power of the main battery is greater than the discharge power of the external charger.

For example, the controlling may further include: controlling the charging of the main battery to be performed by the maximum charge power of the main battery when the maximum charge power of the main battery is smaller than the discharge power of the external charger; and controlling the charging of the swap battery to be performed by a minimum value of a difference between the discharge power of the external charger and the maximum charge power and the maximum charge power of the swap battery.

Furthermore, to achieve the above objective, the electric vehicle according to various exemplary embodiments of the present disclosure may include the main battery and the swap battery; and a charge and discharge management controller which is configured to determine whether the vehicle is started, and which is configured to control discharging of the main battery to be performed after discharging the swap battery, or is configured to control charging of the swap battery to be performed after charging the main battery according to whether the vehicle is started, based on maximum charge and discharge powers of each of the main battery and the swap battery.

For example, the charge and discharge management controller may be configured to control the discharging of the swap battery to be performed by the maximum discharge power of the swap battery and may control the discharging of the main battery to be performed by a difference between the driver demand power and the maximum discharge power of the swap battery when the driver demand power is greater than the maximum discharge power of the swap battery when the vehicle is started and the driver demand power requires battery discharge.

For example, the charge and discharge management controller may check whether the main battery is capable of being charged or discharged when the driver demand power is the maximum discharge power of the swap battery or less than the maximum discharge power, and may control the discharging of the swap battery to be performed by the driver demand power when the main battery is not capable of being charged or discharged.

For example, the charge and discharge management controller may be configured to control the charging of the main battery to be performed by the driver demand power when the driver demand power is the maximum charge power of the main battery or less when the vehicle is started and the driver demand power requires battery charge.

For example, the charge and discharge management controller may be configured to control the charging of the main battery to be performed by the maximum charge power of the main battery, and may control the charging of the swap battery to be performed by a difference between the driver demand power and the maximum charge power of the main battery when the driver demand power is greater than the maximum charge power of the main battery.

For example, the charge and discharge management controller may check whether charging by the external charger is performed when a state of charge (SOC) value of the swap battery is not the preset first reference value or less when the starting of the vehicle stops.

For example, the charge and discharge management controller may be configured to control the charging of the swap battery to be performed by the discharge power of the external charger when the main battery is fully charged (SOC 100%) and the SOC value of the swap battery is the preset second reference value or less when the charging by the external charger is performed.

According to the electric vehicle and the power control method of a same of the present disclosure, according to whether the vehicle is started, when a driver requires battery discharge, the swap battery is controlled to be preferentially discharged, and when the driver requires battery charge, the main battery is controlled to be preferentially charged so that the SOC value of the main battery is always secured, reducing the number of charging times of the vehicle and the period of charging time thereof, and improving the driving performance of the vehicle.

Effects obtained from the present disclosure are not limited to effects described above, and other effects not described above will be clearly appreciated from the following description by those skilled in the art.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of an electric vehicle provided with a removable swap battery according to various exemplary embodiments of the present disclosure;

FIG. 2 is a block diagram of a charge and discharge management controller which performs the power control of the electric vehicle according to the exemplary embodiment of the present disclosure; and

FIG. 3, FIG. 4, and FIG. 5 are flowcharts of the power control method of the electric vehicle according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Terms including an ordinal number, such as first and second, etc., may be used to describe various elements, but the elements are not limited by the terms. The terms are used only for distinguishing one element from another.

It will be understood that when an element is referred to as being “coupled” or “connected” to another element, it may be directly coupled or connected to the another element, or intervening elements may be present therebetween. On the other hand, it should be understood that when an element is referred to as being “directly coupled” or “directly connected” to another element, there are no intervening elements present.

Singular forms include plural forms unless the context clearly indicates otherwise.

In the present specification, it should be understood that terms such as “comprises” or “have” are intended to designate that features, numbers, steps, operations, components, parts, or combinations thereof described in the specification exist, but do not preclude the possibility of the existence or addition of one or more other features, numbers, steps, operations, components, parts, or combinations thereof.

Hereinafter, the exemplary embodiment included in the present specification will be described in detail with reference to the accompanying drawings, but the same or similar components regardless of reference numerals are assigned the same reference numerals, and overlapping descriptions thereof will be omitted.

Furthermore, a unit or control unit included in names such as a hybrid control unit (HCU) and a vehicle control unit (VCU) is only a term widely used in the naming of a controller that is configured to control the specific function of a vehicle, but does not mean a generic function unit. For example, to control a function for which each controller is responsible, the controller may include a communication device that communicates with other controllers or sensors, a memory that stores an operating system, a logic command, and input/output information, and one or more processors that perform judgment, calculation, and determination necessary for controlling the function in charge.

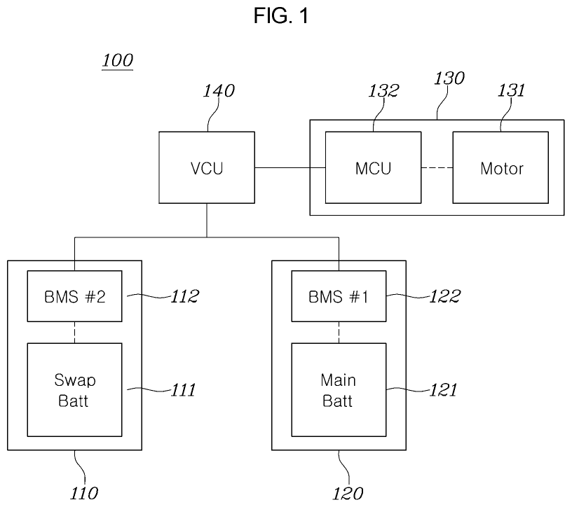

First, the components of an electric vehicle according to the exemplary embodiment of the present disclosure will be described with reference to FIG. 1.

FIG. 1 is a block diagram of the electric vehicle provided with a removable swap battery according to the exemplary embodiment of the present disclosure.

Referring to FIG. 1, the electric vehicle 100 according to the exemplary embodiment of the present disclosure may include a swap battery portion 110, a main battery portion 120, a power drive portion 130, a vehicle control unit 140, and an output device 150. FIG. 1 focuses on components related to the exemplary embodiment, and in the exemplary embodiment of an actual electric vehicle 100, the electric vehicle 100 may include fewer or more components.

Hereinafter, each component of the electric vehicle 100 will be described.

The swap battery portion 110 may include the swap battery 111 and a second battery management system (BMS) 112. The second battery management system 112 may manage the voltage, current, temperature, state of charge (SOC), and state of health (SOH) of the swap battery 111, and may control the charging and discharging of the swap battery 111. Furthermore, the second battery management system 112 may preset and manage the upper and lower limits for the SOC value of the swap battery 111, and may store the cell type information and rated capacity information of the swap battery 111. Furthermore, the second battery management system 112 may transmit information related to the swap battery 111 to the outside through a predetermined vehicle communication protocol (for example, a controller area network (CAN)), and may receive a command for charging and discharging the swap battery 111.

Although not shown in FIG. 1, the swap battery portion 110 may be provided with a cooling device configured for cooling the swap battery 111, for example, an air cooling fan, and in the instant case, the second battery management system 112 may control the operation state of the fan according to the state of the swap battery 111 or the speed of the vehicle. of course, the swap battery portion 110 may be cooled in a natural cooling method, or may be cooled by water cooling by disposing a cooling pad, through which a coolant circulates, in a portion of the vehicle to which the swap battery portion 110 is mounted.

Meanwhile, the swap battery portion 110 may be mounted on the roof of the electric vehicle 100 or accommodated in a space in a trunk or under the vehicle, and may be connected to the vehicle in a form of a trailer by having a separate wheel, but this is exemplary and is not limited thereto.

As illustrated in the drawing, the main battery portion 120 may include the main battery 121 and a first battery management system 122, and is always provided by being fixed to the vehicle. The first battery management system 122 may manage the voltage, current, temperature, state of charge (SOC), and state of health (SOH) of the main battery 121, and may control the charging and discharging of the main battery 121.

The power drive portion 130 may include a motor 131 and a motor control unit (MCU) 132 which is configured to control the motor 131.

The vehicle control unit 140 may determine a required driving force according to the value of an accelerator pedal position sensor (APS), and may determine a required braking force according to the value of a brake pedal position sensor (BPS). The vehicle control unit 140 determines a driving torque or regenerative braking torque to be output by the motor 131 of the power drive portion 130 according to the required driving force or the required braking force, and may transmit a torque command according to the driving torque or regenerative braking torque to the motor control unit 132 or an inverter. Furthermore, the vehicle control unit 140 may transmit a charge or discharge command for the main battery 121 or the swap battery 111 to an associated system of the first battery management system 122 and the second battery management system 112 according to a driving situation, and the state of the main battery 121 and the swap battery 111.

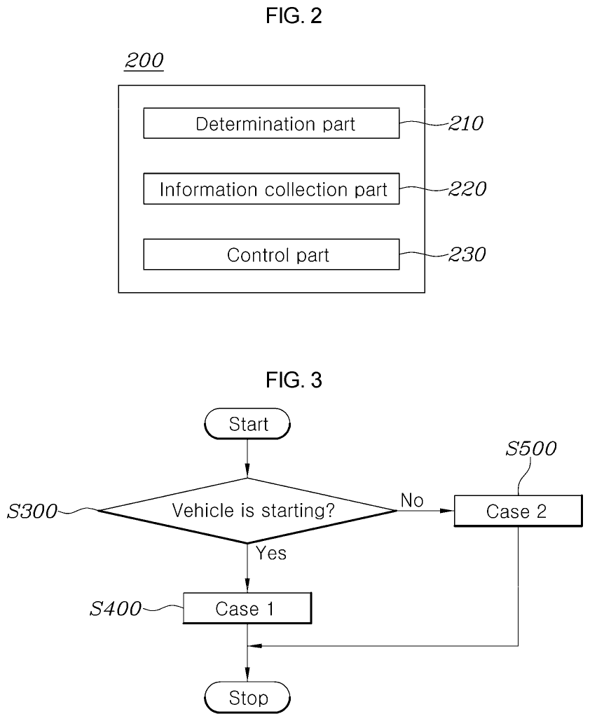

Meanwhile, FIG. 2 is a block diagram of a charge and discharge management controller 200 which performs the power control of the electric vehicle according to the exemplary embodiment of the present disclosure. According to the exemplary embodiment of the present disclosure, the electric vehicle may further include the charge and discharge management controller 200 which determines whether the vehicle is started, and which is configured to control the discharging of the main battery 121 to be performed after the discharging of the swap battery 111 or is configured to control the charging of the swap battery 111 to be performed after the charging of the main battery 121 according to whether the vehicle is started, based on the maximum charge and discharge powers of each of the main battery 121 and the swap battery 111. Furthermore, the charge and discharge management controller 200 may include a determination portion 210, the information collection portion 220, and a control portion 230.

The determination portion 210 may determine whether the vehicle is started. In a general internal combustion engine vehicle, an engine is operated through fuel injection and ignition, and thus ignition (IG) ON/OFF indicates whether the vehicle is ready to drive or not, and when the engine is running, it is expressed as the vehicle being started. As a concept corresponding to the IG ON/OFF, it is possible to indicate whether a vehicle is ready to drive by EV Ready ON/OFF in the case of the electric vehicle and by HEV Ready ON/OFF in the case of a hybrid vehicle, depending on a powertrain. However, in an exemplary embodiment of the present disclosure, for convenience, regardless of whether the engine or the motor 131 is provided, whether a vehicle is ready to drive is referred to as whether a vehicle is started, and in the following description, whether a vehicle is ready to drive will be referred to as “whether a vehicle is started”.

Furthermore, the information collection portion 220 may collect information related to the main battery 121 and the swap battery 111 provided in the electric vehicle 100. As an exemplary embodiment of the present disclosure, the information collection portion 220 may receive information related to the SOC and temperature of each of the main battery 121 and the swap battery 111 through the first battery management system 122 connected to the main battery 121 and the second battery management system 112 connected to the swap battery 111. Furthermore, the information collection portion 220 may determine a maximum charge power and a maximum discharge power of each of the main battery 121 and the swap battery 111, based on the information of the main battery 121 and the swap battery 111 provided by the first battery management system 122 and the second battery management system 112, respectively. For example, the maximum charge power may mean power which may be charged to the maximum according to the current SOC and temperature of the main battery 121 or the swap battery 111 when the charging of the main battery 121 or the swap battery 111 is performed. Additionally, the maximum discharge power may mean power which may be discharged to the maximum according to the current SOC and temperature of the main battery 121 or the swap battery 111 when the discharging of the main battery 121 or the swap battery 111 is performed. This is illustrative, and various methods may be performed when determining the maximum charge power and the maximum discharge power of the main battery 121 and the swap battery 111.

Furthermore, the control portion 230 may control the charging and discharging of the main battery 121 and the swap battery 111 based on whether the vehicle is started, which is determined by the determination portion 210, and the maximum charge power and maximum discharge power of each of the main battery 121 and the swap battery 111, collected by the information collection portion 220. For example, the control portion 230 first charges the main battery 121 when the vehicle is required to be charged. Next, when the charging of the main battery 121 is completed, the control portion 230 may control the charging of the swap battery 111. Additionally, when the vehicle is required to be discharged, the control portion 230 first discharges the swap battery 111 and may control the discharging of the main battery 121 to satisfy required depth of discharge (DOD) when the DOD of the swap battery 111 is smaller than the required DOD.

In the exemplary embodiment of the charge and discharge management controller 200, the charge and discharge management controller 200 may function as a high rank controller which is configured to control the entirety of a powertrain such as the vehicle control unit (VCU) 140 in the case of an electric vehicle, and a hybrid control unit (HCU) in the case of a hybrid vehicle. However, this is illustrative and not necessarily limited thereto. For example, the charge and discharge management controller 200 may be embodied as a controller separate from a high rank controller or may be embodied so that the functions of two or more different controllers are distributed.

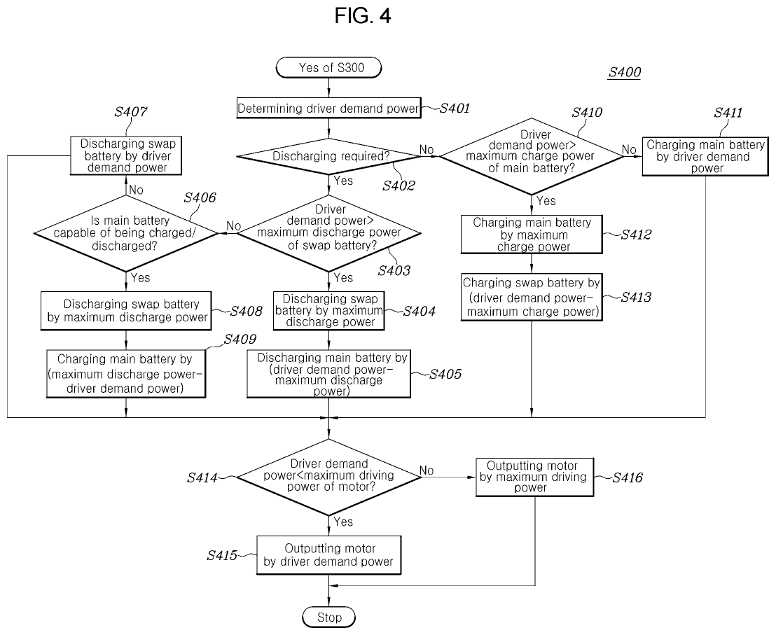

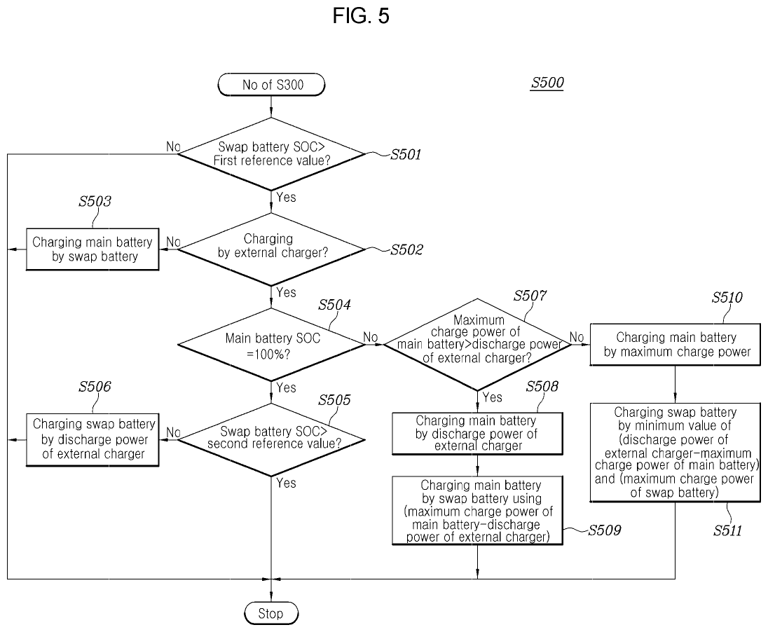

Hereinafter, based on the configuration of the electric vehicle 100 described in FIG. 1 and FIG. 2, the power control method of the electric vehicle 100 according to the exemplary embodiment of the present disclosure will be described with reference to FIG. 3, FIG. 4, and FIG. 5. In FIG. 3, FIG. 4, and FIG. 5, it is assumed that the charge and discharge management controller 200 is embodied as the vehicle control unit 140 for convenience of explanation.

FIG. 3, FIG. 4, and FIG. 5 are flowcharts of the power control method of the electric vehicle according to the exemplary embodiment of the present disclosure.

Referring to FIG. 3, first, the vehicle control unit 140 may determine whether the vehicle is started at S300. Controls for securing the SOC value of the main battery 121 according to whether the vehicle is started may be performed differently at S400 and S500, and hereinafter, each of the controls for securing the SOC value of the main battery 121 will be described in detail.

FIG. 4 is a flowchart of the power control method of the electric vehicle while the vehicle is started according to the exemplary embodiment of the present disclosure.

First, when the vehicle is started (Yes of S300), the vehicle control unit 140 may determine an input driver demand power at S401. A case in which the vehicle is started may mean a situation in which the vehicle is completely configured to drive or is driving, and thus a driver may input the driver demand power required for driving the vehicle. For example, the driver demand power may be determined through APS or BPS provided in the vehicle. Accordingly, the driver demand power input to the vehicle may be a required power corresponding to a driving force output or may be a required power corresponding to regenerative braking.

Furthermore, the present disclosure is intended so that when battery discharge is required, the discharging of the swap battery 111 is preferentially performed, and when battery charge is required, the charging of the main battery 121 is preferentially performed. Accordingly, the vehicle control unit 140 may determine the input driver demand power and may determine whether the driver demand power requires discharging for driving or requires charging for regenerative braking at S402.

When the input driver demand power requires the discharging (Yes of S402), the vehicle control unit 140 may compare the driver demand power with the maximum discharge power of the swap battery 111 at S403. For example, when the discharging is required, the swap battery 111 is maximally used, and to minimize the use of the main battery 121, it may be required to check whether the driver demand power may be satisfied through the swap battery 111. Accordingly, when the driver demand power is greater than the maximum discharge power of the swap battery 111 (Yes of S403), the vehicle control unit 140 may control the discharging of the swap battery 111 to be performed by the maximum discharge power at S404. However, because the driver demand power is greater than the maximum discharge power of the swap battery 111, it may be difficult to satisfy the driver demand power only by the discharging of the swap battery 111. Accordingly, to satisfy the driver demand power, the vehicle control unit 140 may control the discharging of the main battery 121 to be performed by a difference between the driver demand power and the maximum discharge power of the swap battery 111 at S405.

On the other hand, when the driver demand power is smaller than the maximum discharge power of the swap battery 111 (No of S403), the vehicle control unit 140 may determine whether the main battery 121 is capable of being charged or discharged at S406. Because the driver demand power is smaller than the maximum discharge power of the swap battery 111, it is determined whether the main battery 121 is capable of being charged or discharged, and when the main battery 121 may be charged, the main battery 121 may be charged with the discharge power of the swap battery 111. However, in a state in which the charging of the main battery 121 cannot be performed, when the discharging of the swap battery 111 is performed by the driver demand power or more, excess power may be generated, and thus unnecessary power consumption may occur. Accordingly, after determining whether the main battery 121 is capable of being charged or discharged, the vehicle control unit 140 may control the discharging of the swap battery 111 to be performed as much as the driver demand power when the charging and discharging of the main battery 121 cannot be performed (No of S406) at S407. However, when the charging and discharging of the main battery 121 may be performed (Yes of S406), the vehicle control unit 140 may control the discharging of the swap battery 111 to be performed by the maximum discharge power at S408 and may control the charging of the main battery 121 to be performed by a difference between the maximum discharge power of the swap battery 111 and the driver demand power at S409.

When the driver demand power requires battery discharge, the vehicle control unit 140 is configured to control the swap battery 111 to be preferentially discharged and is configured to control the main battery 121 to be discharged by the shortage of the discharging of the swap battery 111 when the discharging of the swap battery 111 is not sufficient, or controls the main battery 121 to be charged by the excess when there is the excess of the discharging of the swap battery 111, so that the SOC value of the main battery 121 may be maintained or increased even while the vehicle is started.

Meanwhile, when the input driver demand power requires charging by regenerative braking (No of S402), the vehicle control unit 140 may compare the driver demand power with the maximum charge power of the main battery 121 at S410. When the driver demand power is the maximum charge power of the main battery 121 or less (No of S410), the vehicle control unit 140 may control the charging of the main battery 121 to be performed by the driver demand power at S411. However, when the driver demand power is greater than the maximum charge power of the main battery 121 (Yes of S410), the vehicle control unit 140 may control the charging of the main battery 121 to be performed by the maximum charge power of the main battery 121 at S412. Furthermore, the vehicle control unit 140 may control the charging of the swap battery 111 to be performed by a difference between the driver demand power and the maximum charge power of the main battery 121 at S413. That is, when the vehicle is required to be charged by regenerative braking, the charging of the main battery 121 may be preferentially performed to secure the SOC value of the main battery 121.

Next, the vehicle control unit 140 may determine whether the driver demand power exceeds the maximum driving power of the motor 131 at S414. The motor 131 provided in the electric vehicle 100 has a limit range in which the motor 131 may be driven, and it may be necessary to determine whether the driver demand power exceeds the limit range of the motor 131. Accordingly, when the driver demand power is smaller than the maximum driving power of the motor 131 (Yes of S414), the vehicle control unit 140 may control the motor 131 so that the motor 131 outputs by the driver demand power at S415 to satisfy the driver demand power required by the vehicle. However, when the driver demand power is greater than the maximum driving power of the motor 131 (No of S414), the vehicle control unit 140 may limit the output of the motor 131 by the maximum driving power of the motor 131 at S416 so that the motor 131 is not used excessively.

Meanwhile, FIG. 5 is a flowchart of the power control method of the electric vehicle when the vehicle's engine stops according to the exemplary embodiment of the present disclosure.

That is, in FIG. 3, when the vehicle is not starting (No of S300), control logic illustrated in FIG. 5 may be performed at S500. Furthermore, in an exemplary embodiment of the present disclosure, the following control logic will be described by determining a state in which a vehicle is not starting as a state in which the vehicle is not completely provided to drive, that is, a state in which the starting of vehicle stops.

First, when the starting of the vehicle stops (No of S300), the vehicle control unit 140 may check whether the SOC value of the swap battery 111 is a preset first reference value or more at S501. For example, the first reference value may be a value preset in the vehicle control unit 140, and in an exemplary embodiment of the present disclosure, the first reference value may mean the SOC 0%. Checking the SOC value of the swap battery 111 is directed to charge the main battery 121 by use of remaining SOC when a certain amount of the SOC value of the swap battery 111 remains even when the starting of the vehicle stops. That is, as an exemplary embodiment of the present disclosure, the vehicle control unit 140 may check whether the SOC value of the swap battery 111 is more than 0%, and may perform no more control of the swap battery when the SOC value of the swap battery is 0% (No of S501).

Furthermore, when the SOC value of the swap battery 111 is more than the first reference value (Yes of S501), the vehicle control unit 140 may determine whether the charging by an external charger is performed at S502. When the charging of by the external charger is not performed (No of S502), the vehicle control unit 140 may control the charging of the main battery 121 to be performed by use of the SOC value of the swap battery 111 at S503.

When the charging by the external charger is performed (Yes of S502), the vehicle control unit 140 may determine whether the main battery 121 is fully charged (SOC 100%) at S504. When the main battery 121 is fully charged (Yes of S504), the charging of the main battery 121 is not required to be performed any longer, and when the charging by the external charger is performed even when the main battery 121 is fully charged, the vehicle control unit 140 may determine whether the SOC value of the swap battery 111 is more than a second reference value at S505. For example, the second reference value may mean a state in which the SOC pre-stored in the vehicle control unit 140 is 100%, and the vehicle control unit 140 may control no more charging to performed when the SOC value of each of the main battery 121 and the swap battery 111 is full (Yes of S505). However, when the SOC value of the swap battery 111 is the second reference value or less (No of S505), the vehicle control unit 140 may control the charging of the swap battery 111 to be performed by the discharge power of the external charger at S506.

However, when the main battery 121 is not fully charged (No of S504), the vehicle control unit 140 may compare the maximum charge power of the main battery 121 with the discharge power of the external charger at S507. When the maximum charge power of the main battery 121 is greater than the discharge power of the external charger (Yes of S507), the vehicle control unit 140 may control the charging of the main battery 121 to be performed by the discharge power of the external charger at S508.

Furthermore, the external charger cannot charge the main battery by providing more power than the discharge power. Accordingly, the main battery 121 may be charged as much as the discharge power of the external charger, and the shortage of the charging of the main battery 121 may be charged to the main battery 121 by the swap battery 111. Accordingly, the vehicle control unit 140 may control the swap battery 111 so that the swap battery 111 charges the main battery 121 by a difference between the maximum charge power of the main battery 121 and the discharge power of the external charger at S509. Accordingly, the main battery 121 may be charged while satisfying the maximum charge power.

However, when the maximum charge power of the main battery 121 is smaller than the discharge power of the external charger (No of S507), the vehicle control unit 140 may control the charging of the main battery 121 to be performed by the maximum charge power at S510. When the main battery 121 is charged beyond the maximum charge power due to sufficiency of the discharge power of the external charger, the main battery 121 may be overcharged, which may adversely affect the state of health (SOH) of the main battery 121. Accordingly, the vehicle control unit 140 is configured to control the main battery 121 to be charged by the maximum charge power even when the discharge power of the external charger is sufficient, preventing the decrease of durability of the main battery 121. Furthermore, after charging the main battery 121 by use of the discharge power of the external charger, the swap battery 111 may also be charged. The vehicle control unit 140 may control the charging of the swap battery 111 to be performed by the minimum value of difference between the discharge power of the external charger and the maximum charge power of the main battery 121 and the maximum charge power of the swap battery 111 at S511. Controlling the charging of the swap battery 111 to be performed by selecting the minimum value may also be intended to prevent overcharging of the swap battery 111.

Although the exemplary embodiment of the present disclosure has been described for illustrative purposes, those skilled in the art will appreciate that various modifications, additions and substitutions are possible, without departing from the scope and spirit of the present disclosure as included in the accompanying claims.

The present disclosure described above may be implemented as a computer-readable code on a medium in which a program is recorded. A computer-readable medium includes all kinds of recording devices in which data readable by a computer system is stored. Examples of computer-readable media include a Hard Disk Drive (HDD), a solid state disk (SSD), a silicon disk drive (SDD), ROM, RAM, a CD-ROM, a magnetic tape, a floppy disk, and an optical data storage device, etc.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A power control method of an electric vehicle including a main battery and a swap battery, the power control method comprising:
determining, by a charge and discharge management controller, whether the vehicle is started; and
controlling, by the charge and discharge management controller, discharging of the main battery to be performed after discharging the swap battery, or charging of the swap battery to be performed after charging the main battery according to whether the vehicle is started, based on maximum charge and discharge powers of each of the main battery and the swap battery.

2. The power control method of claim 1, wherein the controlling includes determining a driver demand power when the vehicle is started.

3. The power control method of claim 2, wherein the controlling further includes:
controlling the discharging of the swap battery to be performed by the maximum discharge power of the swap battery, and controlling the discharging of the main battery to be performed by a difference between the driver demand power and the maximum discharge power of the swap battery when the driver demand power is greater than the maximum discharge power of the swap battery when the vehicle is started and the driver demand power requires battery discharge.

4. The power control method of claim 3, wherein the controlling further includes:
controlling the discharging of the swap battery to be performed by the driver demand power when the main battery is not capable of being charged or discharged after checking whether the main battery is capable of being charged or discharged when the driver demand power is the maximum discharge power of the swap battery or less than the maximum discharge power of the swap battery.

5. The power control method of claim 4, wherein the controlling further includes:
controlling the discharging of the swap battery to be performed by the maximum discharge power of the swap battery, and controlling the charging of the main battery to be performed by a difference between the maximum discharge power of the swap battery and the driver demand power when the main battery is capable of being charged or discharged.

6. The power control method of claim 2, wherein the controlling further includes controlling the charging of the main battery to be performed by the driver demand power when the driver demand power is the maximum charge power of the main battery or less than the maximum charge power of the main battery when the vehicle is started, and the driver demand power requires battery charge.

7. The power control method of claim 6, wherein the controlling further includes:
controlling the charging of the main battery to be performed by the maximum charge power of the main battery, and controlling the charging of the swap battery to be performed by a difference between the driver demand power and the maximum charge power of the main battery when the driver demand power is greater than the maximum charge power of the main battery.

8. The power control method of claim 1, wherein the controlling includes checking whether charging by an external charger is performed when a state of charge (SOC) value of the swap battery is not equal to a preset first reference value or is less than the preset first reference value when the starting of the vehicle stops.

9. The power control method of claim 8, wherein the controlling further includes controlling the charging of the main battery to be performed by the swap battery when the charging by the external charger is not performed.

10. The power control method of claim 8, wherein the controlling further includes controlling the charging of the swap battery to be performed by a discharge power of the external charger when the main battery is fully charged and the SOC value of the swap battery is a preset second reference value or less than the second reference value when the charging by the external charger is performed.

11. The power control method of claim 10, wherein the controlling further includes comparing the maximum charge power of the main battery with the discharge power of the external charger when the charging by the external charger is performed and the main battery is not fully charged.

12. The power control method of claim 11, wherein the controlling further includes:
controlling the charging of the main battery to be performed by the discharge power of the external charger; and
controlling the swap battery so that the swap battery charges the main battery by a difference between the maximum charge power of the main battery and the discharge power of the external charger when the maximum charge power of the main battery is greater than the discharge power of the external charger.

13. The power control method of claim 11, wherein the controlling further includes:
controlling the charging of the main battery to be performed by the maximum charge power of the main battery when the maximum charge power of the main battery is smaller than the discharge power of the external charger; and
controlling the charging of the swap battery to be performed by a minimum value of a difference between the discharge power of the external charger and the maximum charge power and the maximum charge power of the swap battery.

14. An electric vehicle comprising:
a main battery and a swap battery; and
a charge and discharge management controller which is configured to determine whether the vehicle is started, and which is configured to control discharging of the main battery to be performed after discharging the swap battery, or is configured to control charging of the swap battery to be performed after charging the main battery according to whether the vehicle is started, based on maximum charge and discharge powers of each of the main battery and the swap battery.

15. The electric vehicle of claim 14, wherein the charge and discharge management controller is configured to control the discharging of the swap battery to be performed by the maximum discharge power of the swap battery and is configured to control the discharging of the main battery to be performed by a difference between a driver demand power and the maximum discharge power of the swap battery when the driver demand power is greater than the maximum discharge power of the swap battery when the vehicle is started and the driver demand power requires battery discharge.

16. The electric vehicle of claim 15, wherein the charge and discharge management controller is configured to check whether the main battery is capable of being charged or discharged when the driver demand power is the maximum discharge power of the swap battery or less than the maximum discharge power, and is configured to control the discharging of the swap battery to be performed by the driver demand power when the main battery is not capable of being charged or discharged.

17. The electric vehicle of claim 14, wherein the charge and discharge management controller is configured to control the charging of the main battery to be performed by a driver demand power when the driver demand power is the maximum charge power of the main battery or less than the maximum charge power of the main battery when the vehicle is started and the driver demand power requires battery charge.

18. The electric vehicle of claim 17, wherein the charge and discharge management controller is configured to control the charging of the main battery to be performed by the maximum charge power of the main battery, and is configured to control the charging of the swap battery to be performed by a difference between the driver demand power and the maximum charge power of the main battery when the driver demand power is greater than the maximum charge power of the main battery.

19. The electric vehicle of claim 14, wherein the charge and discharge management controller is configured to check whether charging by an external charger is performed when a state of charge (SOC) value of the swap battery is not equal to a preset first reference value or is less than the preset first reference value when the starting of the vehicle stops.

20. The electric vehicle of claim 19, wherein the charge and discharge management controller is configured to control the charging of the swap battery to be performed by a discharge power of the external charger when the main battery is fully charged and the SOC value of the swap battery is a preset second reference value or less than the second reference value when the charging by the external charger is performed.
